(19) United States
(12) Patent Application Publication
(10) Pub. No.: US 2024/0371059 A1
(43) Pub. Date: Nov. 7, 2024

(54) Collaborative Workspace for an Artificial Reality Environment

(71) Applicant: Meta Platforms Technologies, LLC, Menlo Park, CA (US)

(72) Inventors: Matthew Hanson PAKES, Brooklyn, NY (US); Michael James LEBEAU, Amsterdam (NL); Ethan MILLER, London (GB)

(21) Appl. No.: 18/310,582

(22) Filed: May 2, 2023

(51) Int. Cl. G06T 11/60; G06F 3/04815

(52) U.S. Cl. CPC G06T 11/60; G06F 3/04815; G06T 2200/24

(57) ABSTRACT

Aspects of the present disclosure are directed to a collaborative workspace for an artificial reality (XR) environment. Some implementations can take advantage of the capabilities of XR systems when working on collaborative large documents, such as design sheets and spreadsheets. For example, when a user launches a link to a large design sheet in XR, the workspace can show both a large view of the entire collaborative design space, as well as a personal viewport into the area of the design space that the user is working on. The workspace can include a number of collaboration controls, such as being able to follow someone else's viewport, filtering of the large view to include only the area of the sheet where a user's team is working, replaying a user's edits or view while moving around the design sheet, etc.

### TECHNICAL FIELD

The present disclosure is directed to a collaborative workspace for an artificial reality (XR) environment.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR experiences can be observed by a user through a head-mounted display (HMD), such as glasses or a headset.

In recent years, remote working has also become more prevalent. Although remote working can be more convenient for many people, productivity and creativity can decrease without the ease of in-person collaboration. Thus, applications have been developed that allow users to virtually work together (e.g., via video conferencing) to give the feel of in-person working, despite the users' remote locations.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for providing a collaborative workspace in an artificial reality environment.

FIG. 6 is a block diagram illustrating a system of devices on which some implementations can operate to provide a collaborative workspace.

FIG. 7A is a conceptual diagram illustrating an example view from an artificial reality device of a collaborative workspace in an artificial reality environment including a collaborative document and a personal viewport.

FIG. 7B is a conceptual diagram illustrating an example view from an artificial reality device of a collaborative workspace in an artificial reality environment including a collaborative document in which a user is following a personal viewport of another user.

FIG. 7C is a conceptual diagram illustrating an example view from an artificial reality device of a collaborative workspace in an artificial reality environment including a filtered collaborative document and a personal viewport.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to a collaborative workspace for an artificial reality (XR) environment. Some implementations can take advantage of the capabilities of XR systems when working on collaborative large documents, such as design sheets and spreadsheets. For example, when a user launches a link to a large design sheet in virtual reality (VR), the VR workspace can show both a large view of the entire collaborative design space, as well as a personal viewport into the area of the design space that the user is working on. The VR workspace can include a number of collaboration controls, such as being able to follow someone else's viewport, filtering of the large view to include only the area of the sheet where a user's team is working, replaying a user's edits or view while moving around the design sheet, etc. Some implementations can leverage remote desktop streaming technology to an XR device, while others can be run as a webview on the XR device that is streamed from a cloud server.

For example, a user can don an XR head-mounted display (HMD) to view a collaborative workspace shared by coworkers at a company. The coworkers can access the collaborative workspace using their own XR HMDs or two-dimensional (2D) interfaces, such as computers, mobile phones, tablets, etc. The collaborative workspace can include a full view of a large document being collaboratively worked on by the coworkers, such as a slideshow. For each coworker, the collaborative workspace can further include a personal viewport into the slideshow showing only the portion of the slideshow each user is working on, e.g., a particular slide of the slideshow. From the personal viewport, each coworker can make edits to the displayed portion of the slideshow, which can be reflected on the overall view of the slideshow. The coworkers can also have an option to follow the personal viewport of another coworker to see the edits made by that coworker as they're being made in real-time or near-real time.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific technological improvements in the field of remote working and artificial reality. Some implementations can allow users on not only 2D interfaces, such as computers or mobile phones, to access and edit large collaborative documents, but also 3D interfaces, such as XR devices. Some implementations provide a collaborative workspace in which users on XR devices can view other users performing work on a collaborative document, as well as perform their own work within the collaborative document. Advantageously, some implementations provide each user with a personal viewport into a selected portion of the collaborative document, such that the user can make edits to the collaborative document within their own personal space, while still providing a view of the full document that can be shared amongst all the users within the collaborative workspace. In addition, some implementations can leverage the use of a cloud computing system to collect and coordinate edits to the collaborative document from disparate user devices, which can access the collaborative document over different networks at different remote locations. Thus, the user devices do not have to be collocated or on the same network to collaborate on a single, common collaborative document.

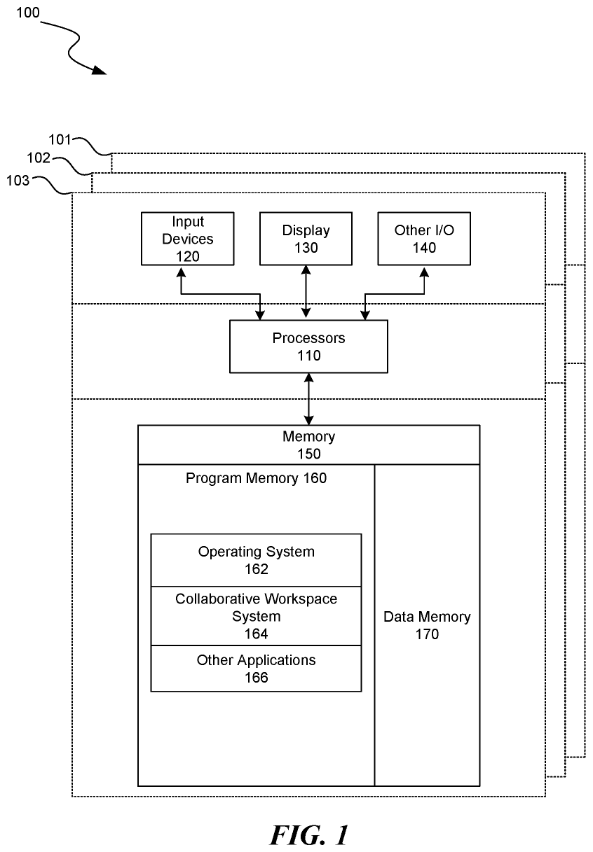

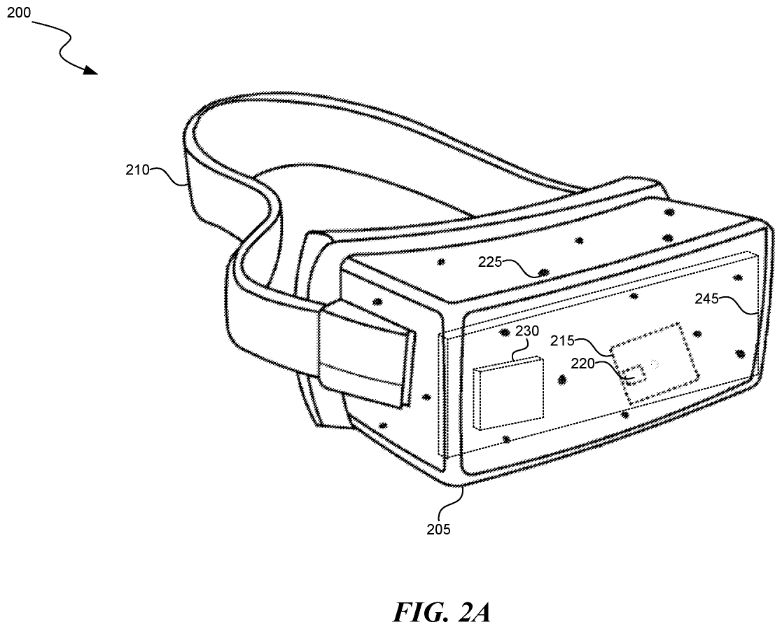

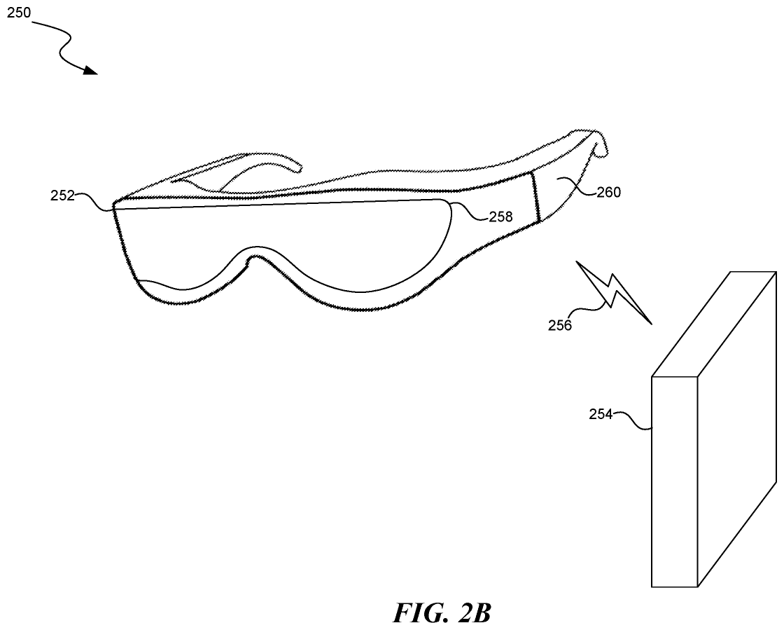

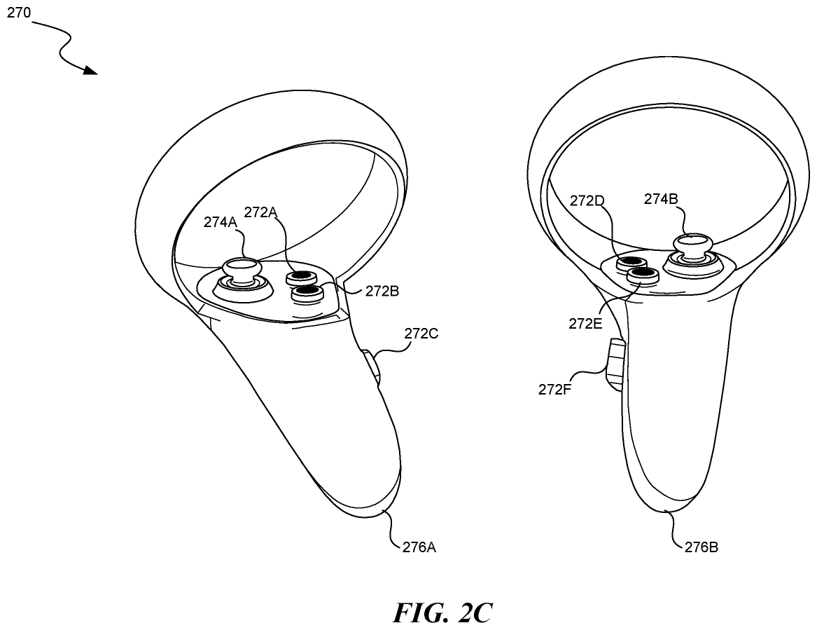

Several implementations are discussed below in more detail in reference to the figures. FIG. 1 is a block diagram illustrating an overview of devices on which some implementations of the disclosed technology can operate. The devices can comprise hardware components of a computing system 100 that can provide a collaborative workspace in an artificial reality (XR) environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, collaborative workspace system 164, and other application programs 166. Memory 150 can also include data memory 170 that can include, e.g., collaborative document rendering data, viewport rendering data, viewport indication data, editing data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

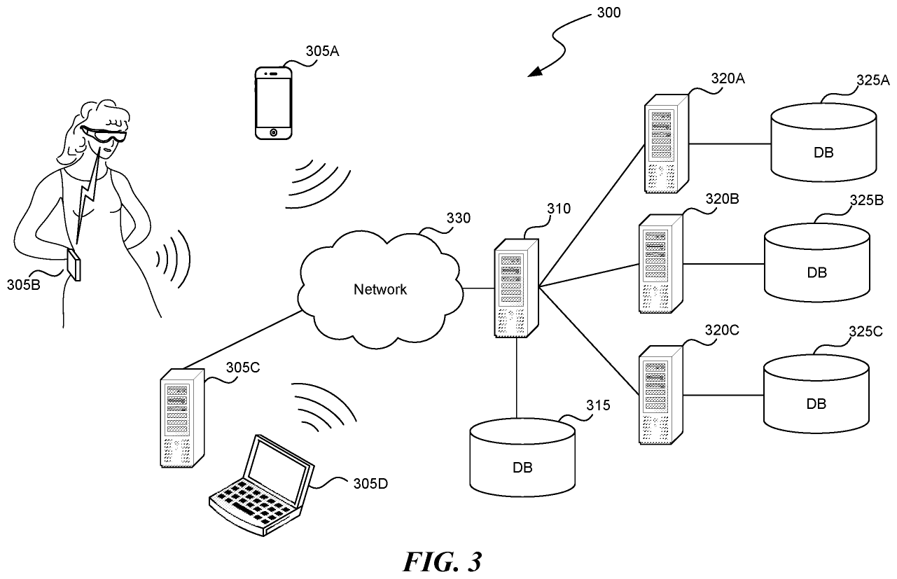

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

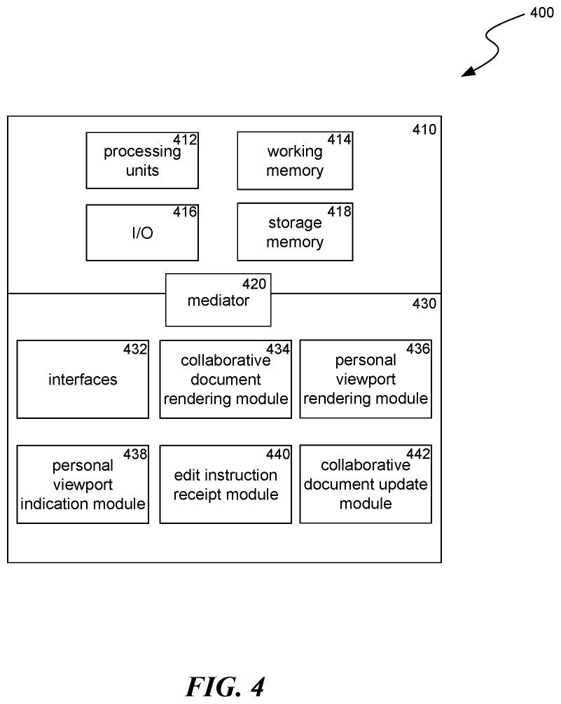

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for providing a collaborative workspace in an artificial reality (XR) environment. Specialized components 430 can include collaborative document rendering module 434, personal viewport rendering module 436, personal viewport indication module 438, edit instruction receipt module 440, collaborative document update module 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

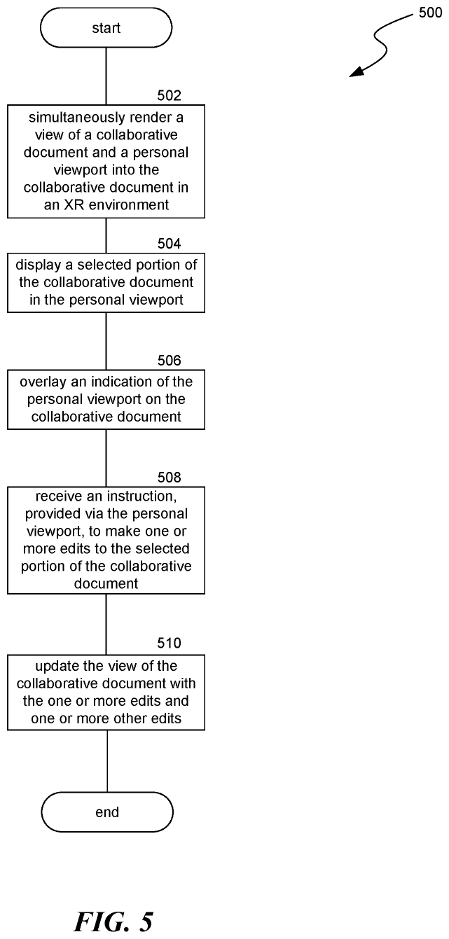

Collaborative document rendering module 434 can render a view of a collaborative document in an artificial reality (XR) environment on an XR device. The collaborative document can be any document capable of being created and/or edited by multiple users, such as a design document, a spreadsheet, a slideshow, a text document, a graphics document, etc., and can include text, graphics, audio, and/or video. The collaborative document can be capable of being simultaneously accessed by multiple users via multiple user devices, such as other XR devices and/or via two-dimensional (2D) interfaces, such as computing devices, tablets, mobile devices, etc. The multiple user devices can access the collaborative document via any suitable network, such as network 330 of FIG. 3. Collaborative document rendering module 434 can render the view of the collaborative document within a collaborative workspace, the collaborative workspace being accessed by the multiple users via the multiple user devices. In some implementations, the collaborative workspace can include avatars, photographs, or other identifiers indicating which users are within the collaborative workspace and/or are accessing the collaborative document. Further details regarding rendering a view of a collaborative document in an XR environment are described herein with respect to block 502 of FIG. 5.

Personal viewport rendering module 436 can render a personal viewport into the collaborative document, rendered by collaborative document rendering module 434, in the XR environment on an XR device. In some implementations, personal viewport rendering module 436 can simultaneously render the personal viewport into the collaborative document while collaborative document rendering module 434 is rendering the collaborative document. The personal viewport can be a virtual object in the XR environment that can be interacted with in the XR environment, such as through a direct touch interaction (e.g., using a hand to make changes to the collaborative document via the personal viewport). The personal viewport can display a selected portion of the collaborative document which can be edited by the user viewing the selected portion via the personal viewport. For example, from within the personal viewport, a user can use her hand to highlight a word or graphic through a double click or swipe motion. In another example, the user can use her hand to make a pinch-and-drag motion to move text or a graphic to another location shown in the personal viewport. In still another example, the user can use her hand to make an up or down motion with her finger, which can scroll the view shown in the personal viewport to another portion of the collaborative document. The user can select the portion of the collaborative document to display in the personal viewport by, for example, touching or gesturing toward the portion of the collaborative document, scrolling within the personal viewpoint, having their personal viewpoint follow that of another user, etc. Further details regarding rendering a view of a personal viewport in an XR environment and displaying a selected portion of a collaborative document in a personal viewport are described herein with respect to blocks 502-504 of FIG. 5.

Personal viewport indication module 438 can display an indication of the personal viewport overlaid on the collaborative document. The indication of the personal viewport can indicate what particular users are viewing in their personal viewport from the collaborative document. For example, the indication can be a highlighting of a selected portion of the collaborative document, a shape enclosing the selected portion of the collaborative document, a color change of the selected portion of the collaborative document, a cursor where the center of the personal viewpoint is looking, etc., which, in some implementations, can be displayed in conjunction with an identifier of the user viewing that portion of the collaborative document. For example, personal viewport indication module 438 can display identifiers of users in conjunction with the portions of the collaborative document that they are accessing via their respective personal viewports, such as names, usernames, photographs, avatars, etc. Further details regarding displaying an indication of a personal viewport overlaid on a collaborative document are described herein with respect to block 506 of FIG. 5.

Edit instruction receipt module 440 can receive an instruction, provided via the personal viewport rendered by personal viewport indication module 438, to make one or more edits to the selected portion of the collaborative document displayed in the personal viewport. Edit instruction receipt module 440 can receive the instruction via user input. For example, a user can perform one or more direct touch interactions with the personal viewport to add and/or modify data shown within the personal viewport, i.e., data within the selected portion of the collaborative document. In some implementations, the user input can be made via one or more controllers (e.g., controller 276A and/or controller 276B of FIG. 2C). In some implementations, the user input can be an audible instruction to edit the portion of the collaborative document, as captured by one or more microphones, and processed using speech recognition techniques.

In some implementations, edit instruction receipt module 440 can receive an instruction, while the user is within the personal viewport, to make an edit to a portion of the collaborative document not shown in the personal viewport, without changing the view within the personal viewport. For example, using her hand or a controller (e.g., controller 276A or controller 276B of FIG. 2C), a user can cast a ray onto the view of the collaborative document to select an area in which the user can add, edit, or remove text, graphics, files, etc. In another example, a user can make an audible announcement to edit a portion of the collaborative document not shown in the personal viewport. For example, when viewing slide 2 in the personal viewport, the user can announce, “Move slide 6 before slide 3,” which can be captured by one or more microphones integral with or in operable communication with the XR device. In some implementations, edit instruction receipt module 440 can receive an instruction, while the user is viewing a selected portion of the collaborative document within the personal viewport, to make an edit to the collaborative document including the selected portion and an additional portion of the collaborative document not shown in the viewport. For example, a user can make an instruction to highlight the text for the entire introduction section of a document, in which the user is working on only a selected portion. Further details regarding receiving an instruction to make one or more edits to a selected portion of a collaborative document are described herein with respect to block 508 of FIG. 5.

Collaborative document update module 442 can update the view of the collaborative document, rendered by collaborative document rendering module 434, with the one or more edits received by edit instruction receipt module 440. In some implementations in which one or more other edits are made by one or more other users via respective personal viewports on respective user devices, collaborative document update module 442 can further update the view of the collaborative document with the one or more other edits made by the one or more other users. Collaborative document update module 442 can receive an indication of such edits from, for example, the other user devices making the edits, and/or from a cloud computing system coordinating edits amongst multiple user devices for the collaborative document. Further details regarding updating a view of a collaborative document with one or more edits are described herein with respect to block 510 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for providing a collaborative workspace in an artificial reality (XR) environment. In some implementations, process 500 can be performed as a response to activation or donning of an XR device. In some implementations, process 500 can be performed as a response to launching an application associated with providing the collaborative workspace. In some implementations, at least a portion of process 500 can be performed by an XR device, such as an XR head-mounted display (HMD), e.g., XR HMD 200 of FIG. 2A and/or XR HMD 252 of FIG. 2B. In some implementations, at least a portion of process 500 can be performed by one or more XR devices in operable communication with an XR HMD, such as external processing components.

At block 502, process 500 can simultaneously render a view of a collaborative document and a personal viewport into the collaborative document in the XR environment on an XR device of a user. The collaborative document can be any document capable of being accessed and/or edited by multiple users, such as a spreadsheet, a design document, a text editing document, a presentation document, a blueprint document, a computer-aided design (CAD) document, a schematics document, etc., and can include text, graphics, audio, video, or any other type of content. In some implementations, the collaborative document can be two-dimensional (which may be a flat or curved panel). In some implementations, process 500 can filter the view of the collaborative document, such as to only show the portions of the collaborative document being accessed and/or edited by the users, to only show the portions of the collaborative document relevant to the user (e.g., based on an attribute of the user, such as the user's qualifications, title, role, team, responsibilities, ability to access sensitive or confidential data, etc.), and/or the like.

In some implementations, the XR device can individually execute an instance of the collaborative document, while in other implementations, a cloud computing system can execute the collaborative document for the multiple user devices accessing the collaborative document. In other words, the cloud computing system can host a global or master instance of the collaborative document in which edits can be made, and coordinate updates to the collaborative document with the multiple user devices. In some implementations, the view of the collaborative document can be streamed to the multiple user devices from the cloud computing system. In some implementations, however, the view of the collaborative document can be streamed to the multiple user devices via a middleman device, such as a two-dimensional (2D) interface. For example, an XR device can stream the collaborative document from a laptop computer, with the laptop computer receiving the stream from a cloud computing system.

The personal viewport can be a virtual object that can be interacted with in the XR environment and can provide a view into the collaborative document from which the user can edit the collaborative document. In other words, changes to the virtual object (e.g., the personal viewport) can cause corresponding changes to the collaborative document. In some implementations, the personal viewport can be interacted with through direct touch in the XR environment, e.g., by tracking the hands in the real-world environment to interact with the personal viewport as a virtual object. In some implementations, the personal viewport can zoom in or out on the portion of the collaborative document, e.g., such that the entire collaborative document or just a portion is displayed in the personal viewport. In some implementations, the personal viewport can be executed on the XR device via a local copy of executable code that locally renders the personal viewport, while in other implementations, the personal viewport can be executed on a cloud computing system by running the executable code on the cloud, and streaming the view of the personal viewport to the XR device.

In some implementations, the collaborative document can be simultaneously accessed by multiple users via multiple user devices. The user devices can include any number of XR devices, such as XR HMDs, and/or any number of 2D interfaces, such as computers, mobile phones, tablets, etc., that are network-enabled. The user devices can provide views of the same collaborative document and other personal viewports into the collaborative document for the other users of the user devices. The multiple user devices can be accessing a same instance of the collaborative workspace in which the collaborative document is rendered.

In some implementations, from within the collaborative workspace, a user can view avatars (or other representations) of other users accessing the collaborative document, and view a rendering of them as they perform work (e.g., modifying documents with their hands, having certain facial expressions, gazing at portions of the collaborative document, looking at their personal viewport, etc.). In some implementations, from within the collaborative workspace, users can audibly speak to each other, as captured by microphones, and such audio can be projected spatially to other users within the collaborative workspace. In some implementations, from within the collaborative workspace, users can access other workplace tools, such as a whiteboard, documents and files relevant to the collaborative document and/or the users working on the collaborative document, a chat area, a private meeting area, etc. In some implementations, process 500 can capture any of such information (e.g., conversations of users within the collaborative workspace, movements of users within the collaborative workspace, whiteboarding within the collaborative workspace, etc.), and associate that information with edits made in a personal viewport at a given time. Thus, in some implementations, a user can access and/or replay activity within the collaborative workspace when the user made particular edits within the personal viewport, which can give context to the user (or other user replaying the edits) as to why certain edits were made.

At block 504, process 500 can display a selected portion of the collaborative document in the personal viewport. In some implementations, the user can select the portion of the collaborative document to display in the personal viewport. For example, the user can gesture toward a particular portion of the collaborative document, e.g., point at a particular place in the collaborative document. In another example, the user can audibly announce which portion of the collaborative document to display in the personal viewport (e.g., “Take me to the ‘conclusion’ portion of the document”). In such an example, one or more microphones integral with or in operable communication with the XR device can capture the audible announcement, and perform speech recognition and text querying techniques to identify the portion of the document to which the user is referring. In still another example, the user can use one or more controllers (e.g., controller 276A and/or controller 276B of FIG. 2C) to point and select the portion of the collaborative document to display in the personal viewport, either by selecting a physical button on the controller, or by hovering over the portion of the collaborative document. Further, the user can select which part of the collaborative document to view by having their personal viewpoint follow that of another user. Yet further, the user can use controls in the personal viewpoint such as scrolling, zooming, etc., to select which part of the collaborative document to view.

In some implementations, process 500 can automatically select the portion of the collaborative document to display in the personal viewport. For example, process 500 can select the portion based on where the user last left off in the collaborative document from a previous viewing and/or editing session. In some implementations, process 500 can select the portion based on one or more attributes of the user, such as a team a user is on, other users that the user works with, a title of the user, a user's education or experience, projects or tasks the user is assigned to, etc. For example, process 500 can select the portion of the document based on where other users are editing the document with whom the user works. In some implementations, process 500 can predict which portion of the collaborative document to select for the personal viewport by applying a machine learning model to the attributes of the user, the content of the collaborative document, attributes of other users accessing the collaborative document, contextual factors (e.g., time of day, time of year, etc.), and/or the like, and can update and refine the model based on feedback from the user regarding the prediction.

At block 506, process 500 can overlay an indication of the personal viewport on the collaborative document. The indication can include any graphical or textual content that indicates what in the collaborative document the user is viewing in the personal viewport. For example, the indication can be a highlighting of the portion of the collaborative document, a coloring of the portion of the collaborative document, a box or other shape around the portion of the collaborative document, etc., in conjunction with an identifier of the user (e.g., the user's name, the user's username, the user's avatar, a picture of the user, etc.). In some implementations, process 500 can overlay indications of other personal viewports of other users on the collaborative document, such that the view of the collaborative document shows what portions are being viewed and/or edited by each user accessing the collaborative document.

At block 508, process 500 can receive an instruction, provided via the personal viewport, to make one or more edits to the selected portion of the collaborative document. As described further herein, the personal viewport can be an interactive element that enables the user to edit the portion of the collaborative document. For example, the user can edit the selected portion of the collaborative document from within the personal viewport using gestures, audible announcements, controllers or other physical input mechanisms, a virtual or physical keyboard, etc.

The one or more edits can be coordinated with one or more other edits made by another user of the multiple users accessing the collaborative document. The one or more other edits can be made by other users via other respective personal viewports. In some implementations, a cloud computing system (e.g., a physical or virtual server remote from the user devices accessing the collaborative document) can coordinate the one or more edits by the user with the one or more edits by other users.

At block 510, process 500 can update the view of the collaborative document with the one or more edits and the one or more other edits. Process 500 can similarly update the personal viewport with the one or more edits, as well as the one or more other edits if such edits are within the selected portion of the collaborative document. In some implementations, a cloud computing system can facilitate updating the view of the collaborative document with the one or more edits and the one or more other edits, as the XR device making the one or more edits may not otherwise have access to the one or more other edits. In some implementations, the user can replay edits made within her personal viewport.

In some implementations, process 500 can receive a request by the user to follow another personal viewport of another user of a user device accessing the collaborative document. In such implementations, process 500 can render the other personal viewport displaying another portion of the collaborative document. When following the other personal viewport, the user can see the other user's edits to the displayed portion of the collaborative document which, in some implementations, is facilitated by a cloud computing system. In some implementations, the user can see the other user's edits while following the other personal viewport in real-time or near real-time, i.e., as the edits are being made to the collaborative document. In some implementations, the user can interact with the other user's personal viewport, e.g., more edits to the portion of the collaborative document displayed in the other user's personal viewport. In some implementations, the user cannot interact with the other user's personal viewport and can instead only view changes made by the other user within his personal viewport. In some implementations, the user can replay edits made by the other user within his respective personal viewport, in order to see the prior versions of the portion of the collaborative document displayed in the followed viewport and ascertain what changes were made by the other user.

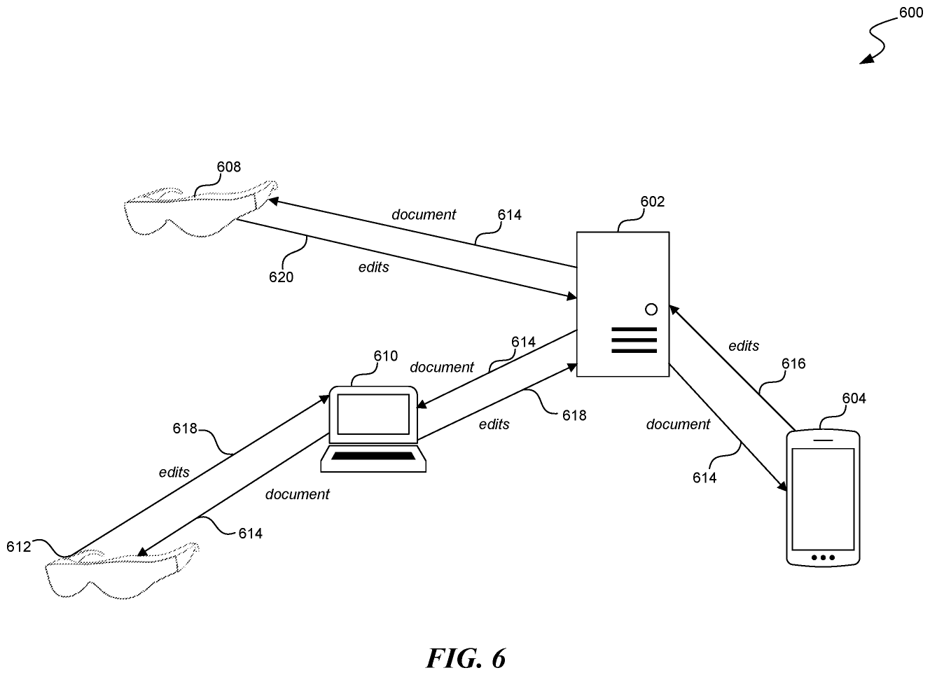

FIG. 6 is a block diagram illustrating a system 600 of devices on which some implementations can operate to provide a collaborative workspace. System 600 can include a cloud computing system 602 in communication with 2D interfaces, e.g., mobile device 604 and computing device 610, and a 3D interface, e.g., XR device 608. Cloud computing system 602 can be in communication with mobile device 604, computing device 610, and XR device 608 over any suitable network, such as network 330 of FIG. 3.

Cloud computing system 602 can store a collaborative document 614. In some implementations, cloud computing system 602 can provide collaborative document 614 directly to mobile device 604 and XR device 608, such that mobile device 604 and XR device 608 can stream collaborative document 614 from cloud computing system 602. In some implementations, however, cloud computing system 602 can provide collaborative document 614 to other devices, such as XR device 612, via a middleman device, such as computing device 610. In such implementations, computing device 610 can stream collaborative document 614 from cloud computing system 602. In turn, XR device 612 can stream collaborative document 614 from computing device 610.

Mobile device 604 can make edits 616 to collaborative document 614 via a personal viewport (not shown) displayed on mobile device 604, and upload edits 616 back to cloud computing system 602. Similarly, XR device 608 can make edits 620 to collaborative document 614 via a personal viewport (not shown) displayed on XR device 608, and upload edits 620 back to cloud computing system 602. XR device 612 can make edits 618 to collaborative document 614 via a personal viewport (not shown) displayed on XR device 612, and upload edits 618 back to computing device 610. Computing device 610 can, in turn, upload edits 618 back to cloud computing system 602. Cloud computing system 602 can update collaborative documents 614 as edits 616-620 are made, and provide collaborative document 614 back to mobile device 604, computing device 614, and XR device 608, such that edits 616-620 are reflected in collaborative document 614 as viewed on mobile device 604, XR device 608, and XR device 612.

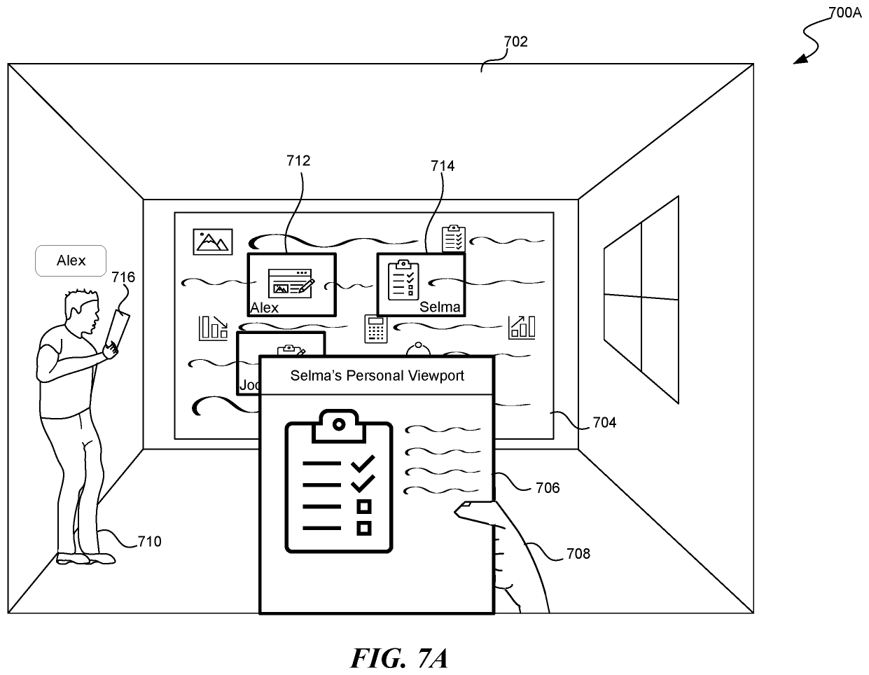

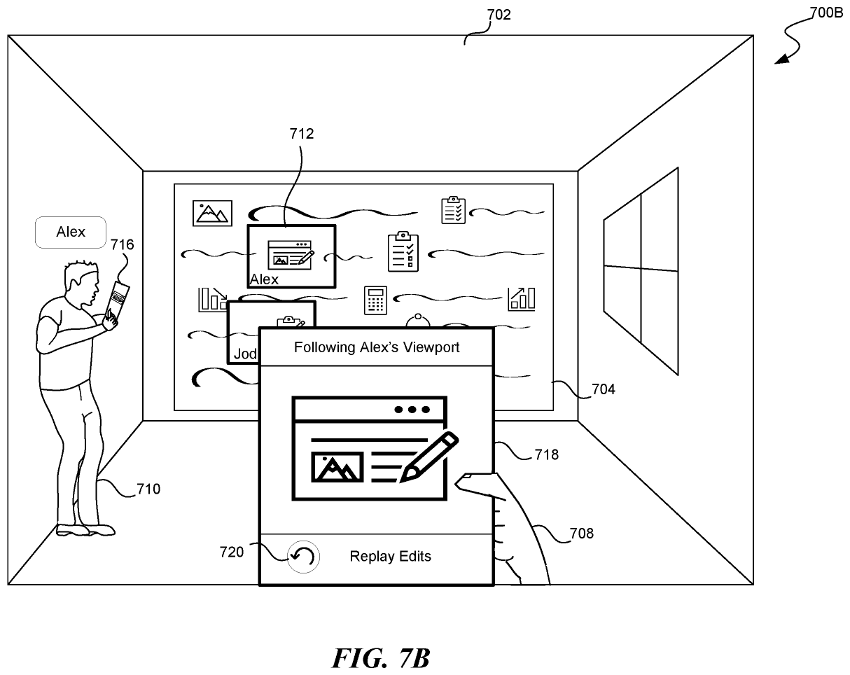

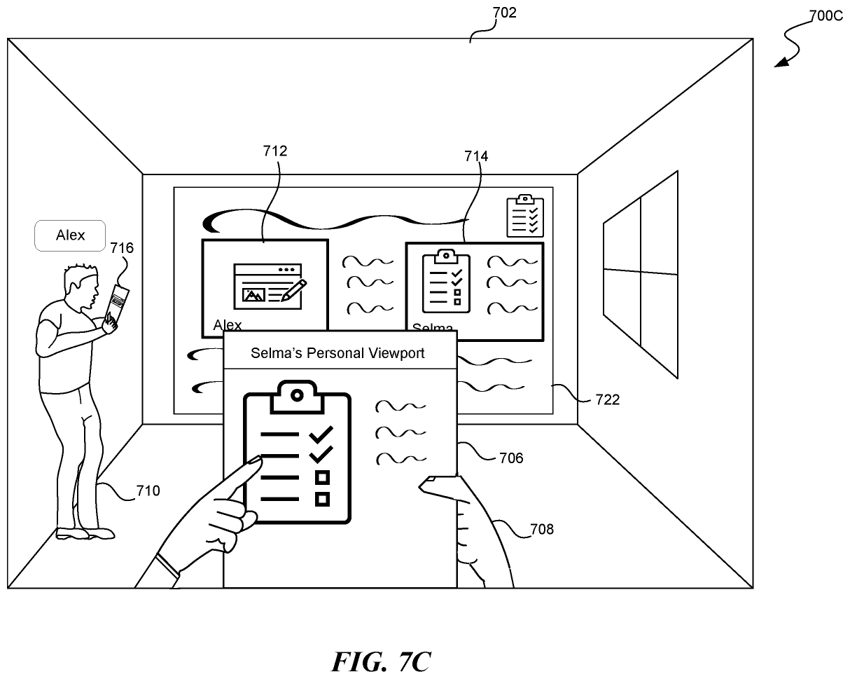

FIG. 7A is a conceptual diagram illustrating an example view 700A from an XR device of a collaborative workspace 702 in an XR environment including a collaborative document 704 and a personal viewport 706. In view 700A, collaborative workspace 702 can include a full view of collaborative document 704 which multiple users are accessing, including a user having avatar 708 (“Selma”) and a user having avatar 710 (“Alex”) in collaborative workspace 702. Selma, having avatar 708, can be holding a tablet displaying her personal viewport 706, which can be providing an editable view into a portion of collaborative document 704. An indication 714 can show where in collaborative document 704 Selma is working, e.g., what she is viewing and/or editing.

Similarly, Alex, having avatar 710, can be holding a tablet displaying his personal viewport 716, which can be providing an editable view into another portion of collaborative document 704. An indication 712 can show where in collaborative document 704 Alex is working, e.g., what he is viewing and/or editing. Similarly, collaborative document 704 can include other indications of where other users are working within collaborative document 704, who can be accessing collaborative workspace 702 via an XR device, such as an XR HMD, or a 2D interface, such as a computer or mobile phone.

FIG. 7B is a conceptual diagram illustrating an example view 700B from an XR device of a collaborative workspace 702 in an XR environment including a collaborative document 704 in which a user (“Selma,” indicated by avatar 708) is following a personal viewport 716 of another user (“Alex,” indicated by avatar 710). Instead of viewing her own personal viewport 706 as in FIG. 7A, Selma can follow Alex's personal viewport 716 in followed viewport 718, and view the portion of collaborative document 704 indicated by indication 712, as well as any edits made by Alex to that portion. In some implementations, Selma can also make edits to the portion of collaborative document 704 indicated by indication 712 in followed viewport 718, while in other implementations, Selma can only be able to passively view edits in followed viewport 718. In some implementations, Selma can further select an option 720 to replay edits to the portion of collaborative document 704 indicated by indication 712, such that she can see where and when particular edits were made, as in an animation.

FIG. 7C is a conceptual diagram illustrating an example view 700C from an XR device of a collaborative workspace 702 in an XR environment including a filtered collaborative document 722 and a personal viewport 706. Some implementations can provide filtered collaborative document 722 in collaborative workspace 702 instead of a full view of collaborative document 704 as shown in FIGS. 7A-7B. For example, filtered collaborative document 722 can display (and, in some implementations, zoom in on) the portions of collaborative document 704 corresponding to indications 712-714 where the user having avatar 710 (i.e., “Alex”) and the user having avatar 708 (i.e, “Selma”) are working. Some implementations can provide filtered collaborative document 722 based on any of a number of factors, such as based on what portions of collaborative document 704 are being edited, what portions of collaborative document 704 correspond to users working together on a team, what portions of collaborative document 704 have the most users working, etc.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing a collaborative workspace in an artificial reality environment, the method comprising:
simultaneously rendering a view of a collaborative document and a personal viewport into the collaborative document in the artificial reality environment on an artificial reality device of a user, wherein:
the collaborative document is simultaneously being accessed by multiple users via multiple user devices, including an other artificial reality device providing both an other view of the collaborative document and an other personal viewport into the collaborative document for an other user of the other artificial reality device;
the personal viewport A) is a virtual object that can be interacted with through direct touch in the artificial reality environment and B) displays a selected portion of the collaborative document, and
an indication of the personal viewport and the other personal viewport are overlaid on the collaborative document;
receiving an instruction, provided via the personal viewport, to make one or more edits to the selected portion of the collaborative document, the one or more edits being coordinated by a cloud computing system with one or more other edits made by the other user via the other personal viewport; and
updating the view of the collaborative document with the one or more edits and the one or more other edits as facilitated by the cloud computing system.

2. The method of claim 1, wherein the multiple user devices are accessing a same instance of the collaborative workspace in which the collaborative document is rendered.

3. The method of claim 1, further comprising:
receiving a request to follow the other personal viewport of the other user of the other artificial reality device; and
rendering the other personal viewport displaying an other portion of the collaborative document, the other portion including at least one of the one or more other edits.

4. The method of claim 3, further comprising:
replaying the at least one of the one or more other edits in the other personal viewport.

5. The method of claim 3, further comprising:
filtering the view of the collaborative document to include the portion and the other portion of the collaborative document.

6. The method of claim 1, wherein the view of the collaborative document is updated in real-time as the one or more edits and the one or more other edits are made.

7. The method of claim 1, further comprising:
filtering the view of the collaborative document based on an attribute of the user and the other user of the other artificial reality device.

8. The method of claim 1, wherein the multiple user devices include the artificial reality device, the other artificial reality device, and at least one two-dimensional interface.

9. The method of claim 8, wherein the view of the collaborative document is streamed from a two-dimensional interface of the at least one two-dimensional interface.

10. The method of claim 1, wherein the view of the collaborative document is streamed from the cloud computing system.

11. The method of claim 1, wherein the collaborative document is executed by the cloud computing system for the multiple user devices.

12. A computer-readable storage medium storing instructions that, when executed by a computing system, cause the computing system to perform a process for providing a collaborative workspace in an artificial reality environment, the process comprising:
simultaneously rendering a view of a collaborative document and a personal viewport into the collaborative document in the artificial reality environment on an artificial reality device of a user, wherein:
the collaborative document is simultaneously being accessed by multiple users via multiple user devices;
the personal viewport A) is a virtual object that can be interacted with in the artificial reality environment and B) displays a selected portion of the collaborative document, and
an indication of the personal viewport is overlaid on the collaborative document;
receiving an instruction, provided via the personal viewport, to make one or more edits to the selected portion of the collaborative document, the one or more edits being coordinated with one or more other edits made by an other user of the multiple users; and
updating the view of the collaborative document with the one or more edits and the one or more other edits.

13. The computer-readable storage medium of claim 12, wherein:
the multiple user devices include an other artificial reality device providing both an other view of the collaborative document and an other personal viewport into the collaborative document for the other user of the other artificial reality device,
an indication of the other personal viewport is overload on the collaborative document, and
the one or more other edits are made by the other user via the other personal viewport.

14. The computer-readable storage medium of claim 12, wherein the personal viewport can be interacted with through direct touch in the artificial reality environment.

15. The computer-readable storage medium of claim 12, wherein:
the one or more edits are coordinated with the one or more other edits by a cloud computing system, and
the cloud computing system facilitates updating of the view of the collaborative document with the one or more edits and the one or more other edits.

16. The computer-readable storage medium of claim 12, wherein the multiple user devices are accessing a same instance of the collaborative workspace in which the collaborative document is rendered.

17. A computing system for providing a collaborative workspace in an artificial reality environment, the computing system comprising:
one or more processors; and
one or more memories storing instructions that, when executed by the one or more processors, cause the computing system to perform a process comprising:
simultaneously rendering a view of a collaborative document and a personal viewport into the collaborative document in the artificial reality environment on an artificial reality device of a user, wherein:
the collaborative document is simultaneously being accessed by multiple users via multiple user devices;
the personal viewport A) is a virtual object that can be interacted with in the artificial reality environment and B) displays a selected portion of the collaborative document, and
an indication of the personal viewport is overlaid on the collaborative document;
receiving an instruction, provided via the personal viewport, to make one or more edits to the selected portion of the collaborative document, the one or more edits being coordinated with one or more other edits made by an other user of the multiple users; and
updating the view of the collaborative document with the one or more edits and the one or more other edits.

18. The computing system of claim 17, wherein:
the personal viewport can be interacted with through direct touch in the artificial reality environment,
the multiple user devices include an other artificial reality device providing both an other view of the collaborative document and an other personal viewport into the collaborative document for the other user of the other artificial reality device,
an indication of the other personal viewport is overload on the collaborative document,
the one or more other edits are made by the other user via the other personal viewport,
the one or more edits are coordinated with the one or more other edits by a cloud computing system, and
the cloud computing system facilitates updating of the view of the collaborative document with the one or more edits and the one or more other edits.

19. The computing system of claim 17, wherein the multiple user devices include the artificial reality device, an other artificial reality device of the other user, and at least one two-dimensional interface.

20. The computing system of claim 19, wherein the view of the collaborative document is streamed from a two-dimensional interface of the at least one two-dimensional interface.
